(19) United States
(12) Patent Application Publication
(10) Pub. No.: US 2024/0095319 A1
(43) Pub. Date: Mar. 21, 2024

(54) USE-BASED SECURITY CHALLENGE AUTHENTICATION

(71) Applicant: INTERNATIONAL BUSINESS MACHINES CORPORATION, ARMONK, NY (US)

(72) Inventors: BRIAN GILLIKIN, Washington, DC (US); Zachary A. Silverstein, Georgetown, TX (US); Trinette Ann Brownhill, Montgomery, TX (US); Hua Ni, Chantilly, VA (US)

(21) Appl. No.: 17/933,985

(22) Filed: Sep. 21, 2022

(51) Int. Cl. G06F 21/31

(52) U.S. Cl. CPC G06F 21/316; G06F 2221/2101; G06F 2221/2103

(57) ABSTRACT

Aspects of the present disclosure relate to use-based security challenge authentication. Usage frequency metrics for features of an electric device can be collected over time. A set of critical features can be determined based on the collected usage frequency metrics, where each critical feature has a usage frequency exceeding a usage frequency threshold. A determination can be made whether a condition is met for use-based authentication. In response to determining that the condition is met for use-based authentication, a use-based security challenge can be generated using a critical feature, the use-based security challenge based on use frequency of the critical feature. The generated use-based security challenge can be presented to the user. A response to the use-based security challenge can be received. A sufficiency of the response to the use-based security challenge can be determined. Access to the electronic device can be authorized based on a sufficiency of the response.

### BACKGROUND

The present disclosure relates generally to the field of computing, and in particular, to use-based security challenge authentication.

Authentication mechanisms can be implemented to facilitate access to devices and software resources (e.g., accounts, software applications, etc.). Authentication is typically based on knowledge (e.g., something a user knows, such as a password), possession (e.g., something the user has, such as a key fob), and/or inherence (e.g., something the user is, such as biometrics). Multi-factor authentication (MFA) can utilize multiple authentication factors and can be combined with external access sources (e.g., external devices and/or accounts), requiring the multiple factors to be collectively authenticated prior to granting access.

### SUMMARY

Embodiments of the present disclosure are directed to a method, system, and computer program product for use-based security challenge authentication.

Usage frequency metrics for features of an electric device can be collected over time. A set of critical features of the features can be determined based on the collected usage frequency metrics, where each critical feature of the set of critical features has a usage frequency exceeding a usage frequency threshold. A determination can be made whether a condition is met for use-based authentication. In response to determining that the condition is met for use-based authentication, a use-based security challenge can be generated using a critical feature of the set of critical features, the use-based security challenge based on use frequency of the critical feature. The generated use-based security challenge can be presented to the user. A response to the use-based security challenge can be received from the user. A sufficiency of the response to the use-based security challenge can be determined. Access to the electronic device can be authorized based on a sufficiency of the response to the use-based security challenge.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a high-level block diagram illustrating an example computer system and network environment that can be used in implementing one or more of the methods, tools, modules, and any related functions described herein, in accordance with embodiments of the present disclosure.

FIG. 2 is a block diagram illustrating an example computing environment in which illustrative embodiments of the present disclosure can be implemented.

FIG. 3 is a flow-diagram illustrating an example method for use-based security challenge authentication for device access, in accordance with embodiments of the present disclosure.

FIG. 4 is a flow-diagram illustrating another example method for use-based security challenge authentication for device access, in accordance with embodiments of the present disclosure.

FIG. 5 is a flow-diagram illustrating another example method for use-based security challenge authentication for device access, in accordance with embodiments of the present disclosure.

FIG. 6 is a flow-diagram illustrating another example method for use-based security challenge authentication for device access, in accordance with embodiments of the present disclosure.

FIG. 7 is a flow-diagram illustrating another example method for use-based security challenge authentication for device access, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of computing, and in particular, to use-based security challenge authentication. While the present disclosure is not necessarily limited to such applications, various aspects of the disclosure can be appreciated through a discussion of various examples using this context.

Authentication mechanisms can be implemented to facilitate access to devices and software resources (e.g., accounts, software applications, etc.). Authentication is typically based on knowledge (e.g., something a user knows, such as a password), possession (e.g., something the user has, such as a key fob), and/or inherence (e.g., something the user is, such as biometrics). Multi-factor authentication (MFA) can utilize multiple authentication factors and can be combined with external access sources (e.g., external devices and/or accounts), requiring the multiple factors to be collectively authenticated prior to granting access.

It is common for users to forget log-in credentials to devices (e.g., infrequently accessed devices, old devices, retired devices, inactive devices, secondary devices, etc.). Gaining access to a device where log-in credentials have been forgotten can be cumbersome. For example, access may require authentication dependent on an external account or device. However, this may be problematic as the account(s)/device(s) necessary to reset/access the original log-in credential may similarly be forgotten. Resetting the device to the factory configuration (e.g., a factory reset) is another option. However, resetting the device may wipe all other data on the device. In instances where the user is attempting to unlock their device to access some data stored on the device, this option is not useful, as the data the user is attempting to access could be deleted upon the factory reset. In view of the above, aspects of the present disclosure recognize that improvements are needed in authentication mechanisms required for device access.

Aspects of the present disclosure relate to use-based security challenge authentication. Usage frequency metrics for features of an electric device can be collected over time. A set of critical features of the features can be determined based on the collected usage frequency metrics, where each critical feature of the set of critical features has a usage frequency exceeding a usage frequency threshold. A determination can be made whether a condition is met for use-based authentication. In response to determining that the condition is met for use-based authentication, a use-based security challenge can be generated using a critical feature of the set of critical features, the use-based security challenge based on use frequency of the critical feature. The generated use-based security challenge can be presented to the user. A response to the use-based security challenge can be received from the user. A sufficiency of the response to the use-based security challenge can be determined. Access to the electronic device can be authorized based on a sufficiency of the response to the use-based security challenge.

Aspects of the present disclosure can provide various improvements over existing authentication mechanisms. First, aspects of the present disclosure can provide an alternative option to a factory reset when device access credentials (e.g., a password or Personal Identification Number (pin)) have been forgotten. When access credentials have been forgotten (the authorized user cannot access the device using a currently enabled authentication mechanism), use-based authentication can be provided to the user as another option for accessing their device. Further, because the use-based authentication is based on the user's personal experience with the device (e.g., based on features they use, events they experience, and/or content that has been previously displayed), security of the device can be enhanced as the authorized user of the device is familiar with their own usage history, while unauthorized users may not be. Further still, computing efficiency can be enhanced by selectively generating/presenting use-based security challenges based on conditions such as whether the device has been inactive over a predetermined time threshold and/or whether the device has failed a currently set authentication mechanism. Implementing conditions for determining whether to enable use-based authentication can prevent extraneous processing such that use-based security challenges are not generated/presented when not required. Additionally, because the use-based security challenges may be generated using features determined to be critical, usability is enhanced, as there is a higher likelihood that the authorized user knows the correct answer to the security challenge, and thus, can gain access to the device. This further prevents infrequently used features from being integrated into use-based security challenges, enhancing computing efficiency by preventing generation of use-based security challenges that are potentially unfamiliar to the user, and thus not productive for use-based authentication.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

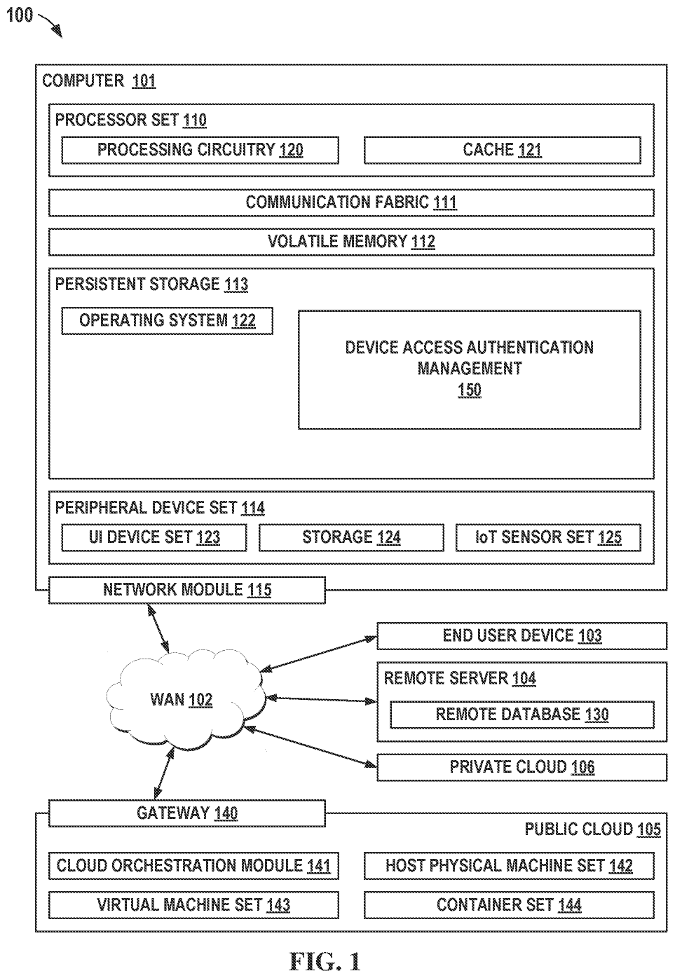

FIG. 1 is a high-level block diagram illustrating an example computer system and network environment 100 that can be used in implementing one or more of the methods, tools, modules, and any related functions described herein, in accordance with embodiments of the present disclosure. Computing environment 100 contains an example of an environment for the execution of at least some of the computer code involved in performing the inventive methods, such as device access authentication management 150. In addition, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and device access authentication management 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some or all of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 includes the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, mixed reality (MR) headset, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

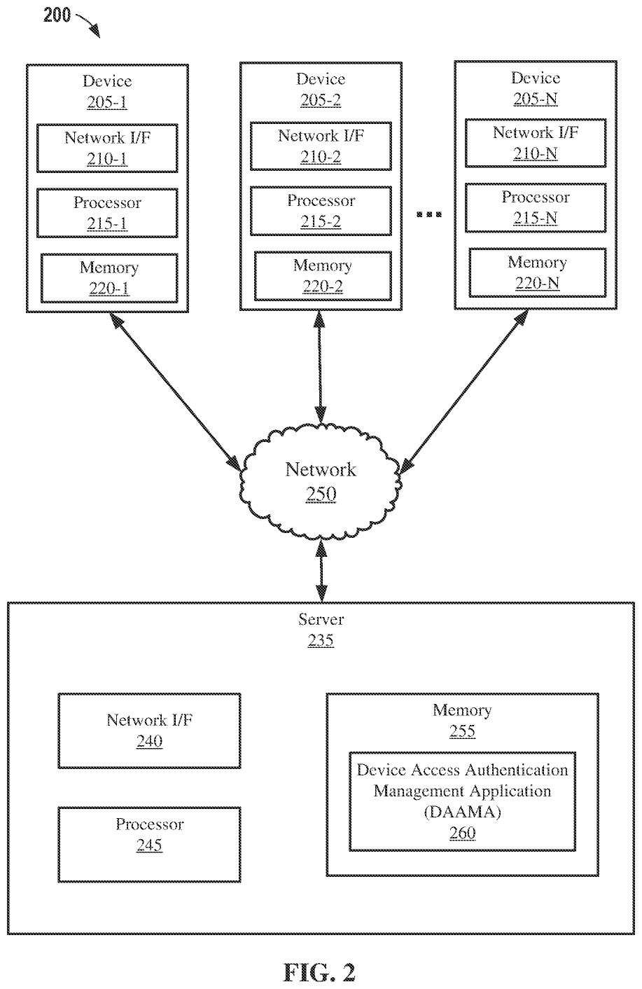

FIG. 2 is a block diagram illustrating an example computing environment 200 in which illustrative embodiments of the present disclosure can be implemented. Computing environment 200 includes a plurality of devices 205-1, 205-2 . . . 205-N (collectively devices 205), at least one server 235, and a network 250.

The devices 205 and the server 235 include one or more processors 215-1, 215-2 . . . 215-N (collectively processors 215) and 245 and one or more memories 220-1, 220-2 . . . 220-N (collectively memories 220) and 255, respectively. The processors 215 and 245 can be same as, or substantially similar to, processor set 110 of FIG. 1. The memories 220 and 255 can be the same as, or substantially similar to volatile memory 112 and/or persistent storage 113 of FIG. 1.

The devices 205 and the server 235 can be configured to communicate with each other through internal or external network interfaces 210-1, 210-2 . . . 210-N (collectively network interfaces 210) and 240. The network interfaces 210 and 240 are, in some embodiments, modems or network interface cards. The network interfaces 210 and 240 can be the same as, or substantially similar to, network module 115 described with respect to FIG. 1.

The devices 205 and/or the server 235 can be equipped with a display or monitor. Additionally, the devices 205 and/or the server 235 can include optional input devices (e.g., a keyboard, mouse, scanner, a biometric scanner, video camera, or other input device), and/or any commercially available or custom software (e.g., browser software, communications software, server software, natural language processing software, search engine and/or web crawling software, image processing software, etc.). For example, devices 205 and/or server 235 can include components/devices such as those described with respect to peripheral device set 114 of FIG. 1. The devices 205 and/or the server 235 can be servers, desktops, laptops, or hand-held devices. The devices 205 and/or the server 235 can be the same as, or substantially similar to, computer 101, remote server 104, and/or end user device 103 described with respect to FIG. 1.

The devices 205 and the server 235 can be distant from each other and communicate over a network 250. In some embodiments, the server 235 can be a central hub from which devices 205 can establish a communication connection, such as in a client-server networking model. Alternatively, the server 235 and devices 205 can be configured in any other suitable networking relationship (e.g., in a peer-to-peer (P2P) configuration or using any other network topology).

In some embodiments, the network 250 can be implemented using any number of any suitable communications media. In embodiments, the network 250 can be the same as, or substantially similar to, WAN 102 described with respect to FIG. 1. For example, the network 250 can be a wide area network (WAN), a local area network (LAN), an internet, or an intranet. In certain embodiments, the devices 205 and the server 235 can be local to each other and communicate via any appropriate local communication medium. For example, the devices 205 and the server 235 can communicate using a local area network (LAN), one or more hardwire connections, a wireless link or router, or an intranet. In some embodiments, the devices 205 and the server 235 can be communicatively coupled using a combination of one or more networks and/or one or more local connections. For example, the first device 205-1 can be hardwired to the server 235 (e.g., connected with an Ethernet cable) while the second device 205-2 can communicate with the server 235 using the network 250 (e.g., over the Internet).

In some embodiments, the network 250 is implemented within a cloud computing environment or using one or more cloud computing services. Consistent with various embodiments, a cloud computing environment can include a network-based, distributed data processing system that provides one or more cloud computing services. Further, a cloud computing environment can include many computers (e.g., hundreds or thousands of computers or more) disposed within one or more data centers and configured to share resources over the network 250. In embodiments, network 250 can be coupled with public cloud 105 and/or private cloud 106 described with respect to FIG. 1.

The server 235 includes a device access authentication management application (DAAMA) 260. The DAAMA 260 can be configured respond to user requests to access devices 205. In particular, the DAAMA 260 can be configured to generate and present use-based security challenges to users in response to access requests to devices 205 in addition to, or as an alternative to, previously set and currently enabled authentication methods (e.g., pins, passwords, etc.). The DAAMA 260 can gauge sufficiency of user responses to use-based security challenges (e.g., whether a user passed the authentication and/or the degree to which the user passed the authentication) to determine whether to grant access to the devices 205 and/or to determine a degree of access to grant to devices 205.

DAAMA 260 can collect historical usage data associated with devices 205 over time. The historical usage data can indicate actions taken by users (e.g., input interactions, such as application launches and associated executable functions), events experienced by users (e.g., errors experienced by the user, notifications received by the user, messages received by the user, etc.), content displayed to users (e.g., images/videos displayed on devices), or any other suitable historical usage data associated with user devices 205. In embodiments, the historical usage data can include usage frequency metrics indicating how often users view or interact with software and/or hardware features of devices. Historical usage data can be used by DAAMA 260 to generate use-based security challenges that can be used to access devices 205.

Usage frequency metrics can be collected for operating system (OS) software features, application software features, storage features (e.g., folders and files), coupled hardware devices (e.g., peripheral devices such as monitors, printers, mice, keyboard, network adapters, etc.), network features, and other software/hardware features associated with the device. Example usage frequency metrics include usage interactions (e.g., clicks, launches, scroll actions, zoom actions, button interactions, touch interactions, and other executable functions associated with device features), viewing time (e.g., time spent viewing particular software/hardware features), and launch time (e.g., time that software features are opened, displayed, or otherwise actively running). Additional usage frequency metrics can include a last access time (e.g., a day/time a particular software/hardware feature was last used) and a first access time (e.g., a day/time a particular software/hardware feature was first used). Table 1 depicts exemplary usage frequency metrics that can be collected by DAAMA 260 over time for a device.

TABLE 1
Example Usage Frequency Metrics of Device

| | | Usage | Viewing | Launch |
|---|---|---|---|---|
| Usage | | Interactions | Time | Time |
| Frequency | | (interactions/ | (minutes/ | (minutes/ |
| Metrics | Name | day) | day) | day) |
| OS Feature 1 | Settings | 5 | 20 | 30 |
| OS Feature 2 | Snipping Tool | 15 | 10 | 15 |
| Application 1 | Weather App | 10 | 30 | 45 |
| Application 2 | Email Client | 100 | 300 | 500 |
| Application 3 | Video Game | 30 | 120 | 180 |
| File 1 | Project | 3 | 5 | 15 |
| | Document | | | |
| File 2 | Project | 2 | 3 | 10 |
| | Presentation | | | |
| Peripheral | Printer 1 | 1 | N/A | N/A |
| Device 1 | | | | |
| Peripheral | Printer 2 | 5 | N/A | N/A |
| Device 2 | | | | |

As shown in Table 1, names, usage interactions, viewing time, and launch time for a variety of software and hardware features are shown. “Usage interactions” can describe actions, controls, activatable functions, etc. executed by a user for software/hardware features described above. For example, a usage interaction for the “Settings” OS feature could include interaction with software controls (e.g., buttons, dials, switches, and other features that allow modification of device settings facilitated by the OS) within the “Settings” window. In the example depicted in Table 1, the “Settings” OS feature has 5 interactions per day. As another example, usage interactions for “Printer 1” and “Printer 2” could be historical print requests issued by a user (e.g., Printer 1 had one print request in the last day and Printer 2 had five print requests in the last day).

“Viewing time” relates to time a user spent viewing the above device features. For example, Application 2 “Email Client” had an active viewing time of 300 minutes per day. In embodiments, viewing time can be based on the time that a software or hardware feature is actively displayed (e.g., a window corresponding to a software feature is displayed (partially or maximized) on a display of the device versus it being launched/opened but in a minimized or hidden state). In some embodiments, viewing time can be based on a time a user is actually viewing the hardware/software feature of the device. For example, gaze detection (e.g., via eye-tracking hardware/software) can be configured to determine features a user is actively looking at over time.

In contrast, “Launch Time” refers to time in which the hardware/software features are actively opened/executed. Launch time is typically greater than or equal to viewing time, as launch time is independent of whether the user is actually viewing the hardware/software feature (e.g., launch time is independent of whether the hardware/software feature is maximized vs. minimized, whether the user is determined to be actually looking at the hardware/software feature via gaze detection, etc.). For example, Application 3 “Video Game” has an active launch time of 180 minutes in the last day, but only has a viewing time of 120 minutes in the last day (e.g., the Video Game application was opened/launched for one more hour than it was actually viewed or displayed/maximized).

It is noted that Table 1 depicts exemplary usage frequency metrics associated with exemplary hardware/software features associated with a device. Any suitable number and/or type of usage frequency metrics (e.g., usage interactions, viewing time, launch time) and/or associated software/hardware features (e.g., OS Features 1-2, Applications 1-3, etc.) of the device can be collected/monitored/determined without departing from the spirit and scope of the present disclosure. Further, though Table 1 indicates that the usage metrics are based on a one day time interval, any suitable time interval for usage frequency metrics can be implemented (e.g., 1 hour, 1 week, 1 month, etc.). Further still, the selected time interval can include usage frequency metrics based on any suitable statistical metric (e.g., a median or average) over the given time interval. For example, Table 1 could depict usage frequency metrics of the given time interval (e.g., the last day), on average per time interval, or a median value per time interval. Thus, the usage frequency metrics shown above could be based on the actual time interval (e.g., the usage frequency metrics of the last 24 hours), an average value of usage frequency metrics over the time interval (e.g., usage frequency metrics on average for a 24 hour period considering multiple days), or a median value of usage frequency metrics over the time interval (e.g., a median value of usage frequency metrics for a 24 hour period considering multiple days).

The above usage frequency metrics (e.g., historical usage data) can be collected in any suitable manner. In embodiments, action capturing software (e.g., integrated within DAAMA 260) can be used to capture usage interactions, viewing time, and/or launch time associated with specific operating system features, applications, storage features (e.g., file/folders), hardware features (e.g., peripheral device use or inputs), networks, etc. of the device. For example, the action capturing software can collect/determine the usage interactions, viewing times, and launch times shown in Table 1. In embodiments, action capturing software can collect event data regarding events experienced by users, such as errors, crashes, notifications, received or transmitted contact (e.g., transmitted or received messages, calls, and the like), etc. In embodiments, a user can manually define one or more historical usage features they desire to have monitored. For example, the user can define that they only desire to have usage interactions monitored (e.g., and not viewing time or launch time). Ultimately, action capturing which monitors/collects the actions, events, execution and/or displayed content associated with device features overtime can be completed to facilitate use-based security challenge authentication by DAAMA 260. In embodiments, monitoring/collecting historical usage data occurs continuously, intermittently, periodically, or any other suitable time interval.

Though the above exemplary historical usage data is depicted as being stored in a table, the historical usage data can be stored in any suitable format and in any suitable location.

Upon collecting historical usage data, such as usage frequency metrics depicted in Table 1, DAAMA 260 can use the usage frequency metrics to generate use-based security challenges. In embodiments, prior to generating/presenting use-based security challenges to a user, a determination can be made whether a condition is met for generating/presenting a use-based security challenge to the user. Conditions for generating a use-based security challenge can vary. In embodiments, a condition for generating a use-based security challenge includes a determination that the device the user is attempting to access has not been accessed since a threshold time period (e.g., a threshold period of inactivity). Any suitable time period (e.g., one day, one week, one month, one year, etc.) can be used as a threshold for determining whether to generate/present a use-based security challenge to a user. As an example, if a threshold time period of inactivity is set to one year, if a user attempts to access their device after one year, a use-based security challenge can be generated and presented to the user for authenticating the user to access the device.

In some embodiments, a condition for generating/presenting a use-based security challenge includes a determination that a user has failed a currently set authentication mechanism. As referenced herein “a currently set authentication mechanism” refers to an authentication mechanism that was previously set and is currently active on the device the user is attempting to access. For example, if an infrequently accessed device is currently protected by a pin, then the currently set authentication mechanism is the pin. Any suitable authentication mechanism can be currently activated/set on the device, including passwords, pins, MFA protocols, biometric authentication methods (e.g., facial recognition and/or fingerprint recognition), and the like. As referenced herein, “failing” a currently set authentication mechanism refers to a determination that the user has not sufficiently authenticated the currently set authentication mechanism. Determining a failure of the currently set authentication method can vary. For example, failing a password authentication method can be determined after a threshold number of incorrect password inputs (e.g., five incorrect password inputs), whereas failing a biometric authentication method can be determined after a single incorrect attempt. Any suitable number of unsuccessful authentication attempts can be considered a failure without departing from the spirit and scope of the present disclosure.

Other conditions for generating/presenting a use-based security challenge can be implemented. In some embodiments, use-based security challenges can be generated/presented periodically (e.g., once every week) during device access requests. In these embodiments, the condition can be considered met based on the periodic time period lapsing. In some embodiments, use-based security challenges can be generated/presented upon any log-in attempt by default. In these embodiments, the condition can be considered being met based on any received log-in attempt to the device. In some embodiments, use-based security challenges can be generated/presented in response to location changes (e.g., the user enters a new or different geo-fenced area). In these embodiments, the condition can be considered to be met based on the device entering a particular geo-location (e.g., determined via a global positioning system (GPS)). In some embodiments, a use-based security challenge can be generated/presented in response to a determination that a user attempting to access the device is not the owner of the device (e.g., via biometric analysis). In these embodiments, the condition can be considered to be met if a determination is made that a user of the device is not the owner (e.g., based on biometric identification mismatch). However, any suitable condition can be set for generating/presenting use-based security challenges to users. In embodiments, the user can define which condition for generating/presenting a use-based security challenge they desire to have set. This can be completed using a graphical user interface (GUI) option implemented on the device (e.g., within a security settings menu).

Upon determining that a condition for generating and presenting a use-based security challenge to a user is met (e.g., if required), the DAAMA 260 can generate a use-based security challenge using the historical usage data. The use-based security challenge can be based on attributes of the historical usage data features. “Attributes” of historical usage features relate to usage metrics (e.g., values) or events associated with collected historical usage data. Table 2 depicts an example set of use-based security challenges generated based on some of the usage frequency metrics depicted in Table 1, above.

TABLE 2
Example Use-Based Security Challenges

| Use-Based | | | | |
|---|---|---|---|---|
| Security | Challenge | Answer | | |
| Challenges | Question | Selection | Format | Answer |
| Challenge 1 | What is your most | A. Weather | Multiple | B. Email |
| | frequently used | App | Choice | Client |
| | Application? | B. Email | | |
| | | Client | | |
| | | C. Video | | |
| | | Game | | |
| Challenge 2 | Printer 1 is the | A. True | True/False | B. False |
| | most commonly | B. False | | |
| | used Peripheral | | | |
| | Device. | | | |
| Challenge 3 | What error did | N/A | Fill in | Blue |
| | you last | | Blank | Screen |
| | experience on this | | | Crash |
| | device? | | | |
| Challenge 4 | How Often do you | N/A | Fill in | 2 Hours |
| | play Video Game? | | Blank | Per Day |
| Challenge 5 | How often do you | N/A | Fill in | 15 |
| | use the snip tool? | | Blank | minutes |
| | | | | Per Day |

As shown in Table 2, a variety of different security challenge formats can be implemented, including multiple choice, true/false, and fill in the blank. “Challenge 1” is an example multiple choice use-based security challenge based on application usage metrics depicted in Table 1. “Challenge 2” is an example true/false use-based security challenge based on peripheral device usage (e.g., device hardware feature usage) depicted in Table 1. “Challenge 3” is an example fill in the blank use-based security challenge based on a recently experienced event by the user (not depicted in Table 1). “Challenge 4” is an example fill in the blank use-based security challenge based on application usage metrics depicted in Table 1. “Challenge 5” is an example fill in the blank security challenge based on operating system usage metrics depicted in Table 1. The above use-based security challenges are merely exemplary, and any suitable historical usage data associated with any suitable hardware/software features of the device can be implemented in any suitable security challenge format without departing from the spirit and scope of the present disclosure.

In embodiments, machine learning and artificial intelligence (AI) based analysis methods can be implemented to generate use-based security challenges based on historical usage data (e.g., usage frequency metrics). Machine learning algorithms that can be used to generate use-based security challenges based on historical usage data (e.g., usage interactions, launch time, viewing time, experienced events, displayed content, etc.) can include but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

In embodiments, any suitable usage attributes of software/hardware features can be implemented into use-based security challenges. However, in some embodiments, only hardware/software features which are determined to be critical are integrated into use-based security challenges. In embodiments, a set of critical device features can be determined based on a comparison between collected usage frequency metrics and one or more usage frequency metric thresholds. The usage metric frequency thresholds implemented to determine whether device features are critical can be based on usage interactions, viewing time, and/or launch time, among other potential usage frequency metrics.

As an example, now referencing Table 1, if a usage frequency metric threshold for application usage is defined such that only applications having at least 80 usage interactions in the last day are integrated into use-based security challenges, then only “Application 2,” “Email Client,” would be integrated into a use-based security challenge. As another example, again referencing Table 1, if a usage frequency metric threshold for operating system feature usage is defined such that only operating system features having a launch time of 20 minutes or more are integrated into use-based security challenges, then only “OS Feature 1,” “Settings” would be integrated into a security challenge. Any suitable usage frequency metric thresholds can be defined to limit the number of device features that can be integrated into use-based security challenges. For example, in some embodiments, the usage frequency metric threshold can be defined such that only features which were last accessed within a threshold time period (e.g., in the last month or year) are integrated into use-based security challenge. This can prevent device features which have not been accessed in a while from being integrated into use-based security challenges.

Upon generating one or more use-based security challenges (e.g., potentially responsive to a determination that a condition for generating is met and potentially limited based on any set usage frequency metric threshold requirements for individual features), the use-based security challenge(s) can be presented to a user. Presenting use-based security challenges to the user can include presenting a graphical user interface (GUI) to the user in response to a user log-in attempt which includes the security challenge(s) in the pre-determined format (e.g., multiple choice, true/false, fill in blank, etc.).

Any suitable number of use-based security challenges can be presented to the user and required to be authenticated prior to granting access to the device. In embodiments, the number of use-based security challenges can depend on a threshold period of inactivity. For example, a first number of use-based security challenges (e.g., three challenges) can be presented to the user after a first threshold period of inactivity (e.g., one month), a second number of use-based security challenges (e.g., five challenges) can be presented to the user after a second threshold period of inactivity (e.g., three months), a third number of use-based security challenges (e.g., ten challenges) can be presented to the user after a third threshold period of inactivity (e.g., one year), etc. In some embodiments, the number of use-based security challenges to present to the user can depend on whether a varying degree of access to the device (e.g., read only access vs. read/write access, only allow access to a limited set of features/functions of the device, etc.) is implemented. In these embodiments, multiple use-based security challenges can be transmitted to the user such that a sufficiency of responses to the use-based security challenges can be ascertained (e.g., a correct number of responses out of a total number of challenges) such that a varying level of access can be granted to the user. However, in embodiments, a single or multiple use-based security challenges can be automatically presented to the user in response to any log-in attempt.

Upon presenting the use-based security challenge(s) to the user, a response from the user can be received. The response can include an answer to the use-based security challenge(s). For example, for a multiple choice or true/false use-based security challenge, an option selection can be received from the user on a graphical user interface (e.g., via a touch input action). Similarly, for fill in the blank use-based security challenges, the user can input text (e.g., via a touch keyboard) into a graphical user interface answer box to attempt to answer the security challenge. This can be completed for each use-based security challenge that is presented to the user. In embodiments, all security challenges can be presented on a single graphical interface, allowing the user to scroll or otherwise navigate through the plurality of security challenges to provide answers.

A determination can then be made whether the user sufficiently answered the security challenge(s) to grant access to the device. This can be completed based on whether the user correctly answered the security challenge(s) (e.g., by comparing the received answer to a stored answer) and/or whether the user correctly answered a threshold number of security challenges correctly. For example, if a single use-based security challenge is presented to the user, a determination can be made that the user sufficiently answered the use-based security challenge if the user provided a correct answer to the security challenge.

In embodiments, the comparison between the response provided by the user and the stored correct answer to the use-based security challenge can allow some variance in the response given (e.g., for fill in the blank answer) for authentication purposes. For example, case sensitivity may not be required and variance in wording/timing can be tolerated. For example, correct answers to “Challenge 4” depicted in Table 2 can include “2 Hours per day,” “two hours per day,” “120 minutes per day,” “over one hour per day,” etc. Tolerance can be permitted to allow different words and values. For example, any answers within 20 minutes (e.g., plus or minus 20 minutes from the actual answer) can be permitted as a correct answer. However, any suitable answer tolerance can be implemented without departing from the spirit and scope of the present disclosure.

In embodiments, a sufficiency of a response to the security challenge(s) from the user can be determined such that a degree of access to the device to grant to the user can be determined. Thus, based on how well the user correctly answers the use-based security challenge, full access, limited access, or no access to the device can be permitted. As an example, if the user answers a first threshold number of security challenges correctly (e.g., 80% or more), then full access to the device can be given, if the user answers a second threshold number of security challenges correctly but lower than the first threshold number of security challenges (e.g., between 60-80%), then limited access to the device can be granted, and if the user answers below the second threshold number of security challenges correctly (e.g., below 60%), then access to the device can be denied. In embodiments, granting limited access can include limiting access to functionality and/or device features. For example, limiting access can include providing read-only access and/or providing access to only a subset of device features (e.g., access only to operating system features and not applications, access to only a certain number of peripheral device features, access to only certain storage locations, access to only certain network features, etc.).

In embodiments if the user does not sufficiently respond to the use-based security challenge(s), then access to the device can be denied. This can include locking the device and preventing the user from accessing functionalities and features of the device. In embodiments, denying access can still permit access to some safety/critical functions of the device, such as power settings, emergency notification settings (e.g., “SOS” emergency contact features), and basic input functions.

It is noted that FIG. 2 is intended to depict the representative major components of an example computing environment 200. In some embodiments, however, individual components can have greater or lesser complexity than as represented in FIG. 2, components other than or in addition to those shown in FIG. 2 can be present, and the number, type, and configuration of such components can vary.

While FIG. 2 illustrates a computing environment 200 with a single server 235, suitable computing environments for implementing embodiments of this disclosure can include any number of servers. The various models, modules, systems, and components illustrated in FIG. 2 can exist, if at all, across a plurality of servers and devices. For example, some embodiments can include two servers. The two servers can be communicatively coupled using any suitable communications connection (e.g., using a WAN 102, a LAN, a wired connection, an intranet, or the Internet).

Though this disclosure pertains to the collection of personal data (e.g., historical usage data), it is noted that in embodiments, users opt-in to the system. In doing so, they are informed of what data is collected and how it will be used, that any collected personal data may be encrypted while being used, that the users can opt-out at any time, and that if they opt-out, any personal data of the user is deleted. Further, the opt-in functionality can allow users to specifically set the historical usage data they choose to have collected. Additionally, opt-in functionality can allow users to define conditions for presenting use-based security challenges, whether or not they choose to allow limited access based on sufficiency of response, specific thresholds referenced above, etc.

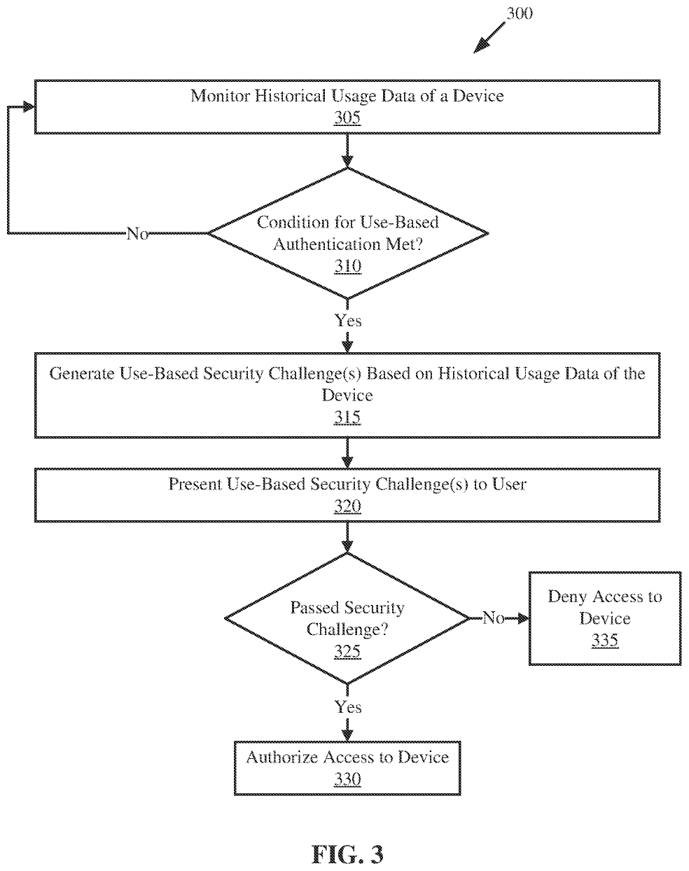

Referring now to FIG. 3, shown is a flow-diagram illustrating an example method 300 for use-based security challenge authentication, in accordance with embodiments of the present disclosure. One or more operations of method 300 can be completed by one or more computing devices (e.g., computer 101, devices 205, server 235). In embodiments, method 300 can be performed by DAAMA 260.

Method 300 initiates at operation 305, where historical usage data of a device is collected. Historical usage data can be the same as, or substantially similar to, historical usage data described with respect to FIG. 2. For example, historical usage data can include usage frequency metrics for device features, events captured for the device, and/or content displayed on the device.

A determination is made whether a condition for use-based authentication is met. This is illustrated at operation 310. Conditions for determining whether to use use-based authentication can be the same as, or substantially similar to, those described with respect to FIG. 2. For example, conditions for use-based authentication can be based on time since last use and/or failed authentication to currently set authentication mechanisms. As an example, if a condition is defined such that if the device has not been accessed within the last 30 days, use-based authentication is enabled, then if a user attempts to access the device after 30 days, then use-based authentication can be determined (e.g., “Yes” at operation 310), and corresponding use-based security challenge(s) can be generated/presented to the user (e.g., at operations 320-325). As another example, if a condition is defined such that if the user fails a currently set authentication mechanism (e.g., provides an incorrect password or pin) then use-based security authentication is enabled, then if the user fails the currently set authentication mechanism, then use-based authentication can be determined (e.g., “Yes at operation 310”), and corresponding use-based security challenges can be generated/presented to the user (e.g., at operation 320-325). In some embodiments, the condition for use-based authentication can simply be a log-in attempt (e.g., any log-in attempt to the device results in use-based authentication).

If a determination is made that a condition for use-based authentication is not met, then operation 310 can return to operation 305, where historical usage data of the device can continue to be monitored. If a determination is made that a condition for use-based authentication is met, then operation 310 can proceed to operation 315.

At operation 315, use-based security challenge(s) can be generated based on the historical usage data of the device. The use-based security challenge(s) can be generated in the same, or a substantially similar manner, as described with respect to FIG. 2. For example, a number of use-based security challenges to generate can be determined based on a threshold period of inactivity (e.g., longer inactivity resulting in more security challenges to present). The use-based security challenges can be generated based on attributes of the historical usage data related to specific device features (e.g., see Table 2). The use-based security challenges can be in any suitable format. In some embodiments, use-based security challenges can be generated using an ML or AI model using historical usage data as inputs for generation.

The use-based security challenge(s) generated at operation 315 are then presented to the user. This is illustrated at operation 320. Presenting the use-based security challenges can be completed in the same, or a substantially similar manner, as described with respect to FIG. 2.

A determination is then made whether the user passed (e.g., sufficiently answered) the security challenge. This is illustrated at operation 325. Determining whether the user passed or sufficiently answered the security challenge can be completed in the same, or a substantially similar manner, as described with respect to FIG. 2.

If a determination is made that the user passed the security challenge at operation 325, then access to the device can be granted (“Yes” at operation 325). This is illustrated at operation 330. If a determination is made that the user did not pass the security challenge at operation 325, then access to the device can be denied (“No” at operation 325). This is illustrated at operation 335. Granting or denying access to the device can be completed in the same, or a substantially similar manner, as described with respect to FIG. 2.

The aforementioned operations can be completed in any order and are not limited to those described. Additionally, some, all, or none of the aforementioned operations can be completed, while still remaining within the spirit and scope of the present disclosure.

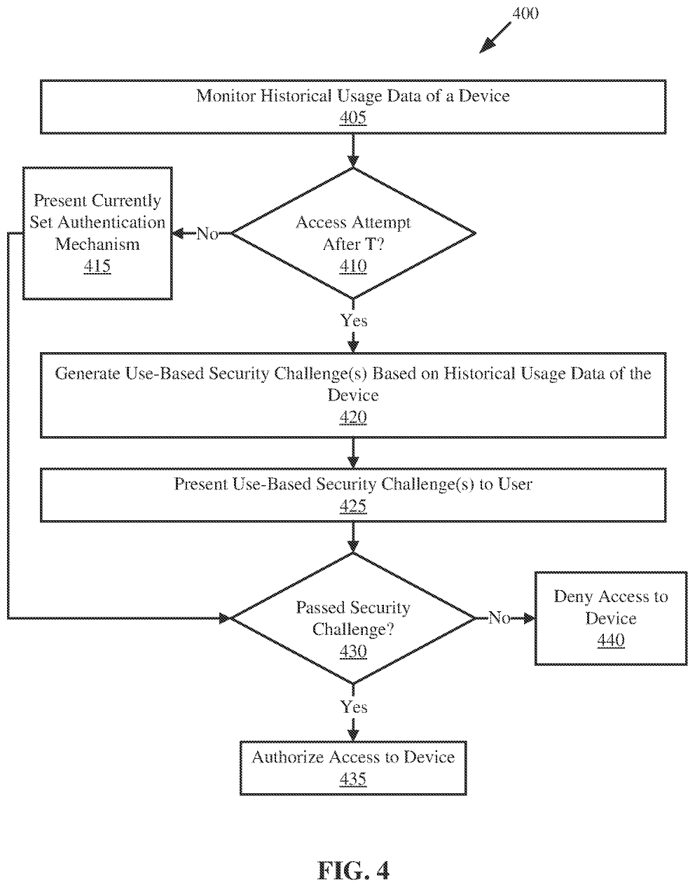

Referring now to FIG. 4, shown is a flow-diagram illustrating another example method 400 for use-based security challenge authentication, in accordance with embodiments of the present disclosure. One or more operations of method 400 can be completed by one or more computing devices (e.g., computer 101, devices 205, server 235).

Method 400 initiates at operation 405, where historical usage data of a device is collected. Historical usage data can be the same as, or substantially similar to, historical usage data described with respect to FIG. 2. For example, historical usage data can include usage frequency metrics for device features, events captured for the device, and/or content displayed on the device.

A determination is made whether an access attempt to log into a device is received after a threshold time period “T.” This is illustrated at operation 410. Determining whether an access attempt to log into the device can be used as a condition for determining whether to use use-based authentication, as in operation 310 of FIG. 3. Any suitable threshold time period, “T,” can be implemented. For example, if a threshold time period for inactivity is set to one month, then if a user attempts to log into their device after one month, one or more use-based security challenges can be generated and presented to the user.

If a determination is made that the user attempts to access their device within the threshold time period of inactivity, “T,” then a currently set authentication mechanism is presented to the user (“No” at operation 410). This is illustrated at operation 415. The currently set authentication mechanisms can be the same as, or substantially similar to, those described with respect to FIG. 2.

If a determination is made that the user attempts to access their device after the threshold time period of inactivity, “T,” then use-based security challenge(s) are generated based on historical usage data of the device (“Yes” at operation 410). This is illustrated at operation 420. The use-based security challenge(s) can be generated in the same, or a substantially similar manner, as described with respect to FIG. 2. The use-based security challenges can be generated based on attributes of the historical usage data related to specific device features (e.g., see Table 2). Any suitable number of use-based security challenges can be generated and presented to the user. The use-based security challenges can be in any suitable format. In some embodiments, use-based security challenges can be generated using an ML or AI model using historical usage data as inputs for generation.

The use-based security challenge(s) generated at operation 420 are then presented to the user. This is illustrated at operation 425. Presenting the use-based security challenges can be completed in the same, or a substantially similar manner, as described with respect to FIG. 2.

A determination is then made whether the user passed (e.g., sufficiently answered) the security challenge. This is illustrated at operation 430. Determining whether the user passed or sufficiently answered the security challenge can be completed in the same, or a substantially similar manner, as described with respect to FIG. 2.

If a determination is made that the user passed the security challenge at operation 430, then access to the device can be granted (“Yes” at operation 430). This is illustrated at operation 435. If a determination is made that the user did not pass the security challenge at operation 430, then access to the device can be denied (“No” at operation 430). This is illustrated at operation 440. Granting and/or denying access to the device can be completed in the same, or a substantially similar manner, as described with respect to FIG. 2.

The aforementioned operations can be completed in any order and are not limited to those described. Additionally, some, all, or none of the aforementioned operations can be completed, while still remaining within the spirit and scope of the present disclosure.

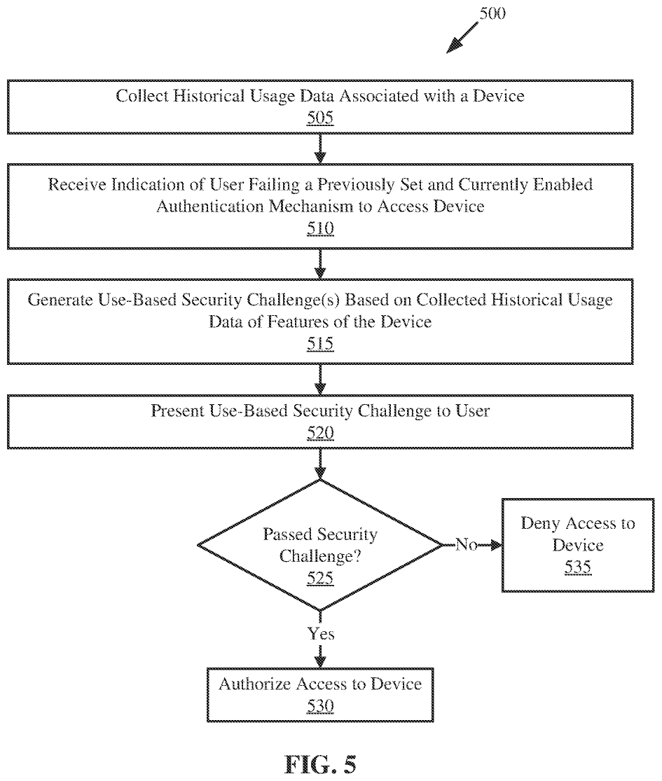

Referring now to FIG. 5, shown is a flow-diagram illustrating another example method 500 for use-based security challenge authentication, in accordance with embodiments of the present disclosure. One or more operations of method 500 can be completed by one or more computing devices (e.g., computer 101, devices 205, server 235).

Method 500 initiates at operation 505, where historical usage data of a device is collected. Historical usage data can be the same as, or substantially similar to, historical usage data described with respect to FIG. 2. For example, historical usage data can include usage frequency metrics for device features, events captured for the device, and/or content displayed on the device.

An indication of a user failing a previously set and currently enabled authentication mechanism to access the device is received. This is illustrated at operation 510. Determining that the user failed a currently enabled authentication mechanism can be completed in the same, or a substantially similar manner, as described with respect to FIG. 2. For example, the indication can be received based on the user failing the currently enabled authentication mechanism a threshold number of times (e.g., a threshold number of incorrect password or pin inputs).

In response to receiving the indication that the user failed the currently enabled authentication mechanism, use-based security challenge(s) can be generated based on the collected historical usage data of features of the device. This is illustrated at operation 515. The use-based security challenge(s) can be generated in the same, or a substantially similar manner, as described with respect to FIG. 2. The use-based security challenges can be generated based on attributes of the historical usage data related to specific device features (e.g., see Table 2). Any suitable number of use-based security challenges can be generated and presented to the user. The use-based security challenges can be in any suitable format. In some embodiments, use-based security challenges can be generated using an ML or AI model using historical usage data as inputs for generation.

The use-based security challenge(s) generated at operation 515 are then presented to the user. This is illustrated at operation 520. Presenting the use-based security challenges can be completed in the same, or a substantially similar manner, as described with respect to FIG. 2.

A determination is then made whether the user passed (e.g., sufficiently answered) the security challenge. This is illustrated at operation 525. Determining whether the user passed or sufficiently answered the security challenge can be completed in the same, or a substantially similar manner, as described with respect to FIG. 2.

If a determination is made that the user passed the security challenge at operation 525, then access to the device can be granted (“Yes” at operation 525). This is illustrated at operation 530. If a determination is made that the user did not pass the security challenge at operation 525, then access to the device can be denied (“No” at operation 525). This is illustrated at operation 535. Granting and/or denying access to the device can be completed in the same, or a substantially similar manner, as described with respect to FIG. 2.

The aforementioned operations can be completed in any order and are not limited to those described. Additionally, some, all, or none of the aforementioned operations can be completed, while still remaining within the spirit and scope of the present disclosure.

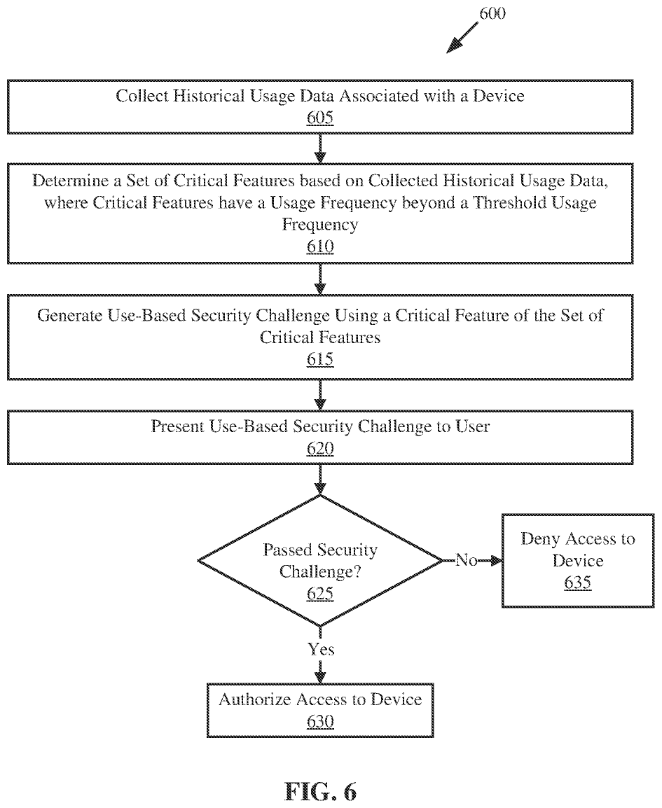

Referring now to FIG. 6, shown is a flow-diagram illustrating another example method 600 for use-based security challenge authentication, in accordance with embodiments of the present disclosure. One or more operations of method 600 can be completed by one or more computing devices (e.g., computer 101, devices 205, server 235).

Method 600 initiates at operation 605, where historical usage data of a device is collected. Historical usage data can be the same as, or substantially similar to, historical usage data described with respect to FIG. 2. For example, historical usage data can include usage frequency metrics for device features, events captured for the device, and/or content displayed on the device.

A set of critical features of the device are determined based on the collected historical usage data, where critical features of the set of critical features each have a usage frequency beyond a threshold usage frequency. This is illustrated at operation 610. In embodiments, determining the set of critical features can be completed in the same, or a substantially similar manner, as described with respect to FIG. 2. For example, the set of critical features can be determined based on features having usage interactions, viewing time, and/or launch time exceeding a usage interaction threshold, viewing time threshold, and/or launch time threshold. However, the set of critical features can be determined in any other suitable manner.

Use-based security challenge(s) can be generated using at least one critical feature of the set of critical features of the device. This is illustrated at operation 615. The use-based security challenge(s) can be generated in the same, or a substantially similar manner, as described with respect to FIG. 2. The use-based security challenges can be generated based on attributes of the critical feature (e.g., see Table 2). Any suitable number of use-based security challenges can be generated and presented to the user based on critical device features. The use-based security challenges can be in any suitable format. In some embodiments, use-based security challenges can be generated using an ML or AI model using historical usage data as inputs for generation.

The use-based security challenge(s) generated at operation 615 are then presented to the user. This is illustrated at operation 620. Presenting the use-based security challenges can be completed in the same, or a substantially similar manner, as described with respect to FIG. 2.

A determination is then made whether the user passed (e.g., sufficiently answered) the security challenge. This is illustrated at operation 625. Determining whether the user passed or sufficiently answered the security challenge can be completed in the same, or a substantially similar manner, as described with respect to FIG. 2.

If a determination is made that the user passed the security challenge at operation 625, then access to the device can be granted (“Yes” at operation 625). This is illustrated at operation 630. If a determination is made that the user did not pass the security challenge at operation 625, then access to the device can be denied (“No” at operation 625). This is illustrated at operation 635. Granting and/or denying access to the device can be completed in the same, or a substantially similar manner, as described with respect to FIG. 2.

The aforementioned operations can be completed in any order and are not limited to those described. Additionally, some, all, or none of the aforementioned operations can be completed, while still remaining within the spirit and scope of the present disclosure.

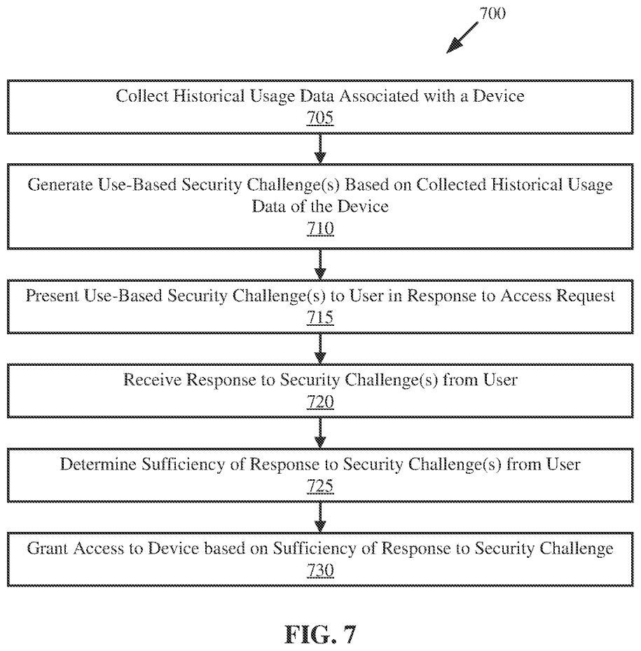

Referring now to FIG. 7, shown is a flow-diagram illustrating another example method 700 for use-based security challenge authentication, in accordance with embodiments of the present disclosure. One or more operations of method 700 can be completed by one or more computing devices (e.g., computer 101, devices 205, server 235).

Method 700 initiates at operation 705, where historical usage data of a device is collected. Historical usage data can be the same as, or substantially similar to, historical usage data described with respect to FIG. 2. For example, historical usage data can include usage frequency metrics for device features, events captured for the device, and/or content displayed on the device.

Use-based security challenge(s) can be generated based on the collected historical usage data of the device. This is illustrated at operation 710. The use-based security challenge(s) can be generated in the same, or a substantially similar manner, as described with respect to FIG. 2. The use-based security challenges can be generated based on attributes of the historical usage data (e.g., see Table 2). Any suitable number of use-based security challenges can be generated and presented to the user based on historical usage data. The use-based security challenges can be in any suitable format. In some embodiments, use-based security challenges can be generated using an ML or AI model using historical usage data as inputs for generation.

The use-based security challenge(s) generated at operation 710 are then presented to the user. This is illustrated at operation 715. Presenting the use-based security challenges can be completed in the same, or a substantially similar manner, as described with respect to FIG. 2.

A response to the use-based security challenge(s) are then received from the user. This is illustrated at operation 720. The response from the user can be the same, or substantially similar to, those described with respect to FIG. 2. For example, based on the format of the use-based security challenge(s) corresponding answers can be received (e.g., selections can be chosen for multiple choice and true/false and/or fill in the blank responses can be input by the user).

A sufficiency of the response to the security challenge(s) received from the user is then determined. This is illustrated at operation 725. In embodiments, a score, percentage, and/or number of correct answers to the security challenge(s) presented to the user can be determined. For example, if five use-based security challenges are presented to the user, and the user answered three of the five correctly, then a score of 0.60 or a percentage of 60% can be calculated. The score, percentage, and/or number of correct answers can be compared one or more threshold to determine a level of sufficiency and ultimately a level of access to grant to the device.

Access is then granted to the device based on the sufficiency of the response to the security challenge. This is illustrated at operation 730. This can be completed in the same, or a substantially similar manner, as described with respect to FIG. 2. For example, based on how well the user correctly answers the use-based security challenge(s), full access, limited access, or no access to the device can be granted. As an example, if the user answers a first threshold number of security challenges correctly (e.g., 90% or more), then full access to the device can be given, if the user answers a second threshold number of security challenges correctly but lower than the first threshold number of security challenges (e.g., between 80-90%), then a first limited access to the device can be granted, if the user answers a third threshold number of security challenges correctly but lower than the second threshold number of security challenges correctly (e.g., between 50-80%), then a second limited access to the device can be granted (e.g., where the second limited access is more restricted than the first limited access), and if the user answers below the third threshold number of security challenges correctly (e.g., below 50%), then access to the device can be denied. Limiting access can include restricting access to functionality and/or device features. For example, limiting access can include providing read-only access and/or providing access to only a subset of device features (e.g., access only to operating system features and not applications, access to only a certain number of peripheral device features, access to only certain storage locations, access to only certain network features, etc.).

In embodiments if the user does not sufficiently respond to the use-based security challenge(s), then access to the device can be denied. This can include locking the device and preventing the user from accessing functionalities and features of the device. In embodiments, denying access can still permit access to some safety/critical functions of the device, such as power settings, emergency notification settings (e.g., “SOS” emergency contact features), and basic input functions.

The aforementioned operations can be completed in any order and are not limited to those described. Additionally, some, all, or none of the aforementioned operations can be completed, while still remaining within the spirit and scope of the present disclosure.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used, and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A system comprising:
one or more processors; and
one or more computer-readable storage media collectively storing program instructions which, when executed by the one or more processors, are configured to cause the one or more processors to perform a method comprising:
collecting usage frequency metrics for features of an electronic device over time;
determining a set of critical features of the features based on the collected usage frequency metrics, wherein each critical feature of the set of critical features has a usage frequency exceeding a usage frequency threshold;
determining whether a condition is met for use-based authentication;
generating, in response to determining that the condition is met for use-based authentication, a use-based security challenge using a critical feature of the set of critical features, the use-based security challenge based on use frequency of the critical feature;
presenting the generated use-based security challenge to a user;
receiving a response to the use-based security challenge from the user;
determining a sufficiency of the response to the use-based security challenge; and
authorizing access to the electronic device based on the sufficiency of the response to the security challenge.

2. The system of claim 1, wherein the condition includes determining whether a threshold period of inactivity on the device has lapsed.

3. The system of claim 1, wherein the condition includes determining that a currently set authentication mechanism has been failed.

4. The system of claim 1, wherein the usage frequency metrics include a number of usage interactions for the features.

5. The system of claim 1, wherein the critical feature is determined to be critical based on a usage interaction metric for the critical feature exceeding a usage interaction threshold.

6. The system of claim 1, where in the usage frequency metrics include a viewing time for the features.

7. The system of claim 1, wherein the critical feature is determined to be critical based on a viewing time metric for the critical feature exceeding a viewing time threshold.

8. The system of claim 1, wherein the use-based security challenge is generated using a machine learning algorithm using the usage frequency metrics as an input.

9. A method comprising:
collecting usage frequency metrics for features of an electronic device over time;
determining a set of critical features of the features based on the collected usage frequency metrics, wherein each critical feature of the set of critical features has a usage frequency exceeding a usage frequency threshold;
determining whether a condition is met for use-based authentication;
generating, in response to determining that the condition is met for use-based authentication, a use-based security challenge using a critical feature of the set of critical features, the use-based security challenge based on use frequency of the critical feature;
presenting the generated use-based security challenge to a user;
receiving a response to the use-based security challenge from the user;
determining a sufficiency of the response to the use-based security challenge; and
authorizing access to the electronic device based on the sufficiency of the response to the security challenge.

10. The method of claim 9, wherein the condition includes determining whether a threshold period of inactivity on the device has lapsed.

11. The method of claim 9, wherein the condition includes determining that a currently set authentication mechanism has been failed.

12. The method of claim 9, wherein the usage frequency metrics include a launch time for each of the features.

13. The method of claim 9, wherein the critical feature is determined to be critical based on a launch time metric for the critical feature exceeding a launch time threshold.

14. The method of claim 9, wherein the use-based security challenge is generated using a machine learning algorithm using the usage frequency metrics as an input.

15. A computer program product comprising one or more computer readable storage media, and program instructions collectively stored on the one or more computer readable storage media, the program instructions comprising instructions configured to cause one or more processors to perform a method comprising:
collecting usage frequency metrics for features of an electronic device over time;
determining a set of critical features of the features based on the collected usage frequency metrics, wherein each critical feature of the set of critical features has a usage frequency exceeding a usage frequency threshold;
determining whether a condition is met for use-based authentication;
generating, in response to determining that the condition is met for use-based authentication, a use-based security challenge using a critical feature of the set of critical features, the use-based security challenge based on use frequency of the critical feature;
presenting the generated use-based security challenge to a user;
receiving a response to the use-based security challenge from the user;
determining a sufficiency of the response to the use-based security challenge; and
authorizing access to the electronic device based on the sufficiency of the response to the security challenge.

16. The computer program product of claim 15, wherein the condition includes determining whether a threshold period of inactivity on the device has lapsed.

17. The computer program product of claim 15, wherein the condition includes determining that a currently set authentication mechanism has been failed.

18. The computer program product of claim 15, wherein the usage frequency metrics include a viewing time for each of the features.

19. The computer program product of claim 15, wherein the critical feature is determined to be critical based on a viewing time metric for the critical feature exceeding a viewing time threshold.

20. The computer program product of claim 15, wherein the use-based security challenge is generated using a machine learning algorithm using the usage frequency metrics as an input.
